(19) United States
(12) Patent Application Publication
(10) Pub. No.: US 2008/0120804 A1
(43) Pub. Date: May 29, 2008

(54) Spring balance assembly

(76) Inventors: Jason L. Annes, Crown Point, IN (US); Michael Tyler, Mokena, IL (US)

Correspondence Address: BANNER & WITCOFF, LTD., TEN SOUTH WACKER DRIVE, SUITE 3000, CHICAGO, IL, 60606, US

(21) Appl. No.: 11/523,778

(22) Filed: Sep. 18, 2006

(51) Int. Cl. E05F 1/16

(52) U.S. Cl. 16/198; 16/197

(57) ABSTRACT

A balance assembly for a sash window slidable within a master frame includes first and second springs, each having a coiled portion and a free end adapted to be attached to a shoe, and first and second substantially identical spring holders. The spring holder includes a plate adapted to be attached to the master frame, a first connector, a second connector, a first spring support, and a second spring support. The first connector is cooperatively dimensioned with the second connector such that the first connector of one spring holder connects to the second connector of the other spring holder. The spring holder can support the spring in one of two configurations. In the first configuration, the coiled portion of the spring is supported by the first spring support, and in the second configuration, the coiled portion of the spring is supported by the second spring support.

### CROSS-REFERENCE TO RELATED APPLICATIONS

None.

### FEDERALLY SPONSORED RESEARCH OR DEVELOPMENT

None.

### TECHNICAL FIELD

The invention relates to a spring balance assembly for a sash window, and more specifically, to a spring balance assembly having complementary connectors for connecting spring holders together and supports for supporting a coil spring in one of two different configurations.

### BACKGROUND OF THE INVENTION

Spring balance assemblies for use in sash windows are widely known and used. However, prior balance assemblies have certain disadvantages in their design and usage. The present invention is provided to solve the problems discussed above and other problems, and to provide advantages and aspects not provided by prior balance assemblies of this type. A full discussion of the features and advantages of the present invention is deferred to the following detailed description, which proceeds with reference to the accompanying drawings.

### SUMMARY OF THE INVENTION

The present invention provides a spring balance assembly for a sash window assembly. The sash window assembly includes a sash window slidable within a master frame and a shoe attached to the sash window. The balance assembly includes first and second springs, each having a coiled portion and a free end adapted to be attached to the shoe, and first and second spring holders for supporting the springs.

Each spring holder includes a plate adapted to be attached to the master frame, a first connector, a second connector, a first spring support located on the plate, and a second spring support located on the plate. The first connector is cooperatively dimensioned with the second connector such that in a first connecting arrangement, the first connector of the first spring holder connects to the second connector of the second identical spring holder, and in a second connecting arrangement, the second connector of the first spring holder connects to the first connector of the second spring holder. The spring holder supports the spring in one of a first configuration and a second configuration. In the first configuration, the coiled portion of the spring is supported by the first spring support, and in the second configuration, the coiled portion of the spring is supported by the second spring support.

According to one aspect of the invention, the first connector is a connection member extending from a first end of the plate, and the second connector is a receiver positioned at a second end of the plate opposite the first end. The receivers of the first and second spring holders are cooperatively dimensioned with the connection members thereof such that the receiver of the second spring holder receives the connection member of the first spring holder or the receiver of the first spring holder receives the connection member of the second spring holder in an alternate connecting arrangement.

According to another aspect of the invention, the connection member is a tongue, and the receiver is a groove. In one embodiment, the tongue and the receiver have complementary dovetail shapes.

According to another aspect of the invention, a first spring support has a platform and the second spring support has a post. In the first configuration, the spring is supported by the first spring support such that the coiled portion of the spring sits upon the platform. In the second configuration, the coiled portion of the spring is mounted upon a drum and the drum is mounted on the second spring support.

According to further aspects of the invention, the platform is a smoothly curved cup structure located proximate the first end of the plate, and in the first configuration, the coiled portion of the spring sits within the cup structure. Additionally, the post is located proximate a center of the plate.

According to another aspect of the invention, the spring holder includes a deflector located proximate the second end of the plate. In one embodiment, the deflector of each spring holder is smoothly curved and has a radius of curvature similar to a radius of curvature of the cup structure of the spring support.

According to another aspect of the invention, the plate of the spring holder has a strengthening rib extending along a back surface thereof.

The present invention also provides a spring holder containing some or all of the features described above, for use with a spring balance assembly in a sash window assembly.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front elevation view of a window assembly having a spring balance assembly installed therein, shown in a closed position;

FIG. 2 is a front elevation view of the window assembly of FIG. 1, shown in an open position;

FIG. 3 is a partial perspective view of a spring balance assembly of the present invention, showing the spring balance assembly connected to a master frame and a shoe;

FIG. 4 is an exploded view of the spring balance assembly of FIG. 3;

FIG. 5 is a front elevation view of a spring balance assembly of the present invention having springs hanging from the same side of the balance assembly;

FIG. 6 is a front elevation view of a spring balance assembly of the present invention having springs hanging from opposing sides of the balance assembly;

FIG. 7 is a side view of the spring balance assembly of FIG. 6;

FIG. 8 is a perspective view of two connected spring holders of a spring balance assembly of the present invention;

FIG. 9 is a perspective view of one of the spring holders of FIG. 8;

FIG. 10 is a reverse perspective view of the spring holder of FIG. 9;

FIG. 11 is a perspective view of the spring holder of FIG. 9 having a spring supported in a first arrangement;

FIG. 12 is a perspective view of the spring holder of FIG. 9 having a spring supported in a second arrangement;

FIG. 13 is a perspective view of another embodiment of a spring holder of the present invention;

FIG. 14 is a reverse perspective view of the spring holder of FIG. 13;

FIG. 15 is a front elevation view of two spring holders of FIG. 13 connected together; and

FIG. 16 is a perspective view of an embodiment of a coil spring of a spring balance assembly of the present invention.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

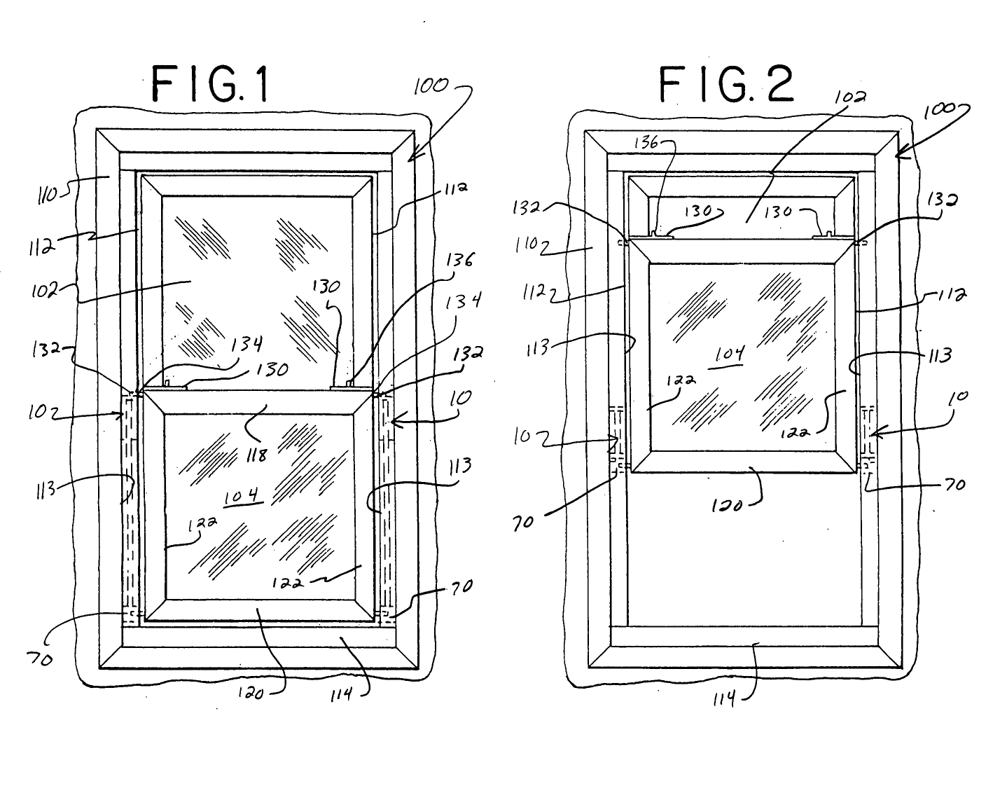

Referring to FIGS. 1 and 2, a balance assembly 10 is affixed to a sash window assembly 100. The sash window assembly 100 shown in FIGS. 1-2 is a double-hung window assembly having an upper pivotal sash window 102 and a lower pivotal sash window 104 in a master frame 110. In general terms, the master frame 110 includes a pair of opposed vertical guide rails 112 adapted to slidably guide the sash windows 102, 104. The master frame further includes a footer or lower horizontal element 114. The guide rail 112 defines an elongated channel 113 in which the spring balance assembly 10 is mounted. Typically, the master frame 110 has a set of guide rails 112 for each sash window 102,104 and the balance assembly 10 is mounted to each guide rail 112 to balance the sash window 102, 104.

The sash window 104 has a top rail 118, a base rail 120, and a pair of stiles or side rails 122. A tilt latch 130 is mounted in an upper portion of the top rail 118. The tilt latch 130 has a bolt 132 with a nose portion 134 adapted to extend into the elongated channel 113. The tilt latch 130 has an actuator 136 and a spring (not shown) wherein the actuator 136 is designed to retract the bolt 132 into the housing of the latch 130 against the biasing force of the spring.

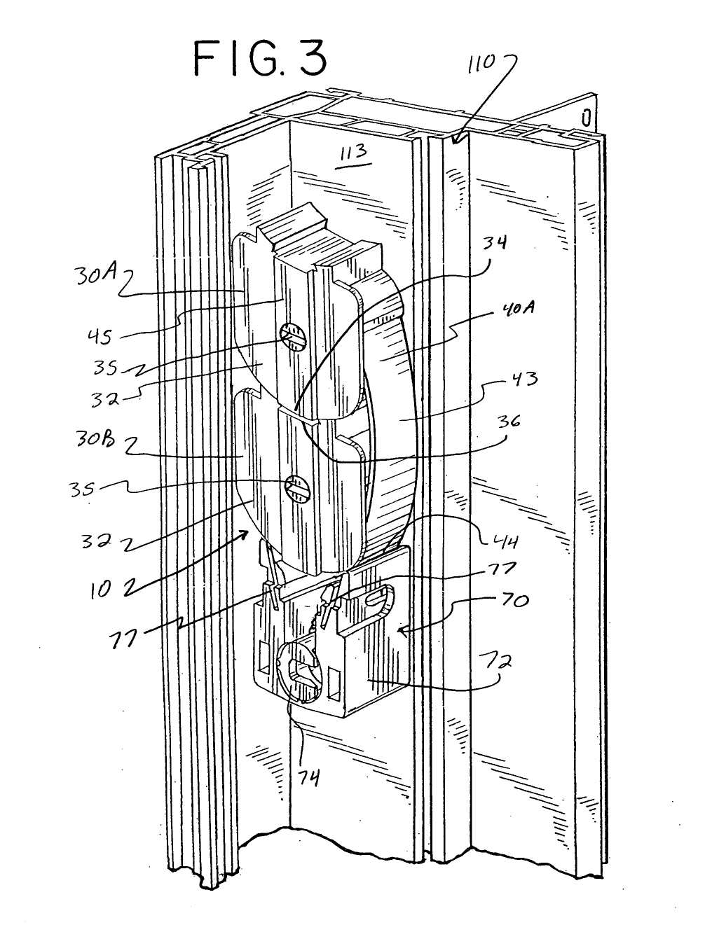

As shown in FIGS. 3-7, the balance assembly 10 generally includes a first spring holder 30A, a second spring holder 30B connected to the first spring holder, a first coil spring 40A, and a second coil spring 40B. The first and second coil springs 40 are connected to a shoe or pivot brake assembly 70.

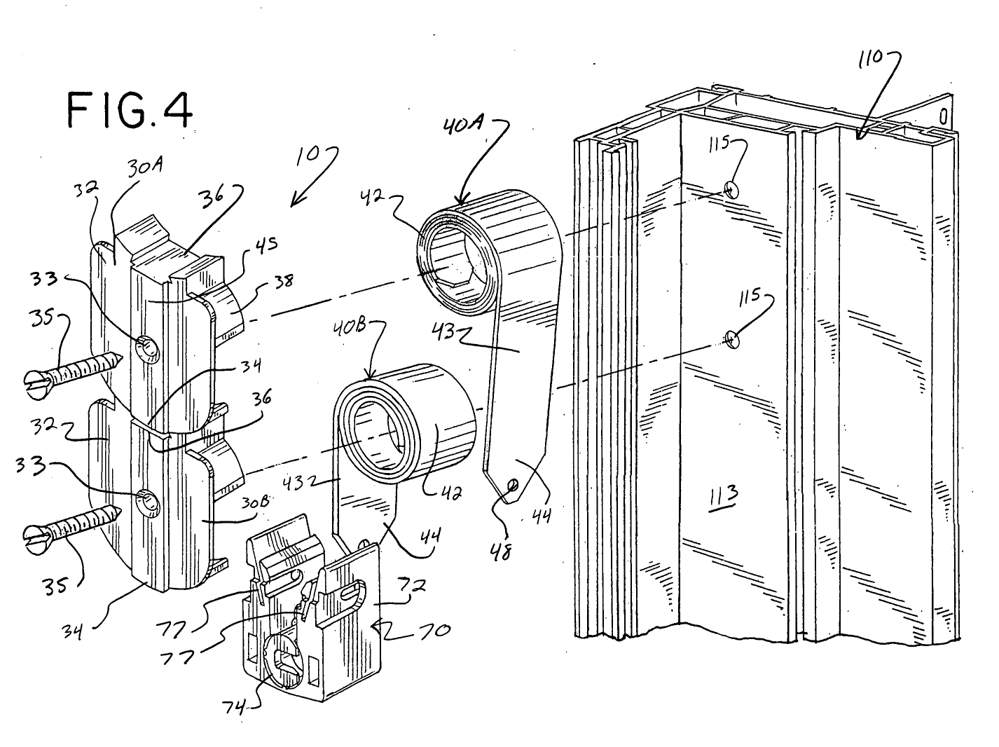

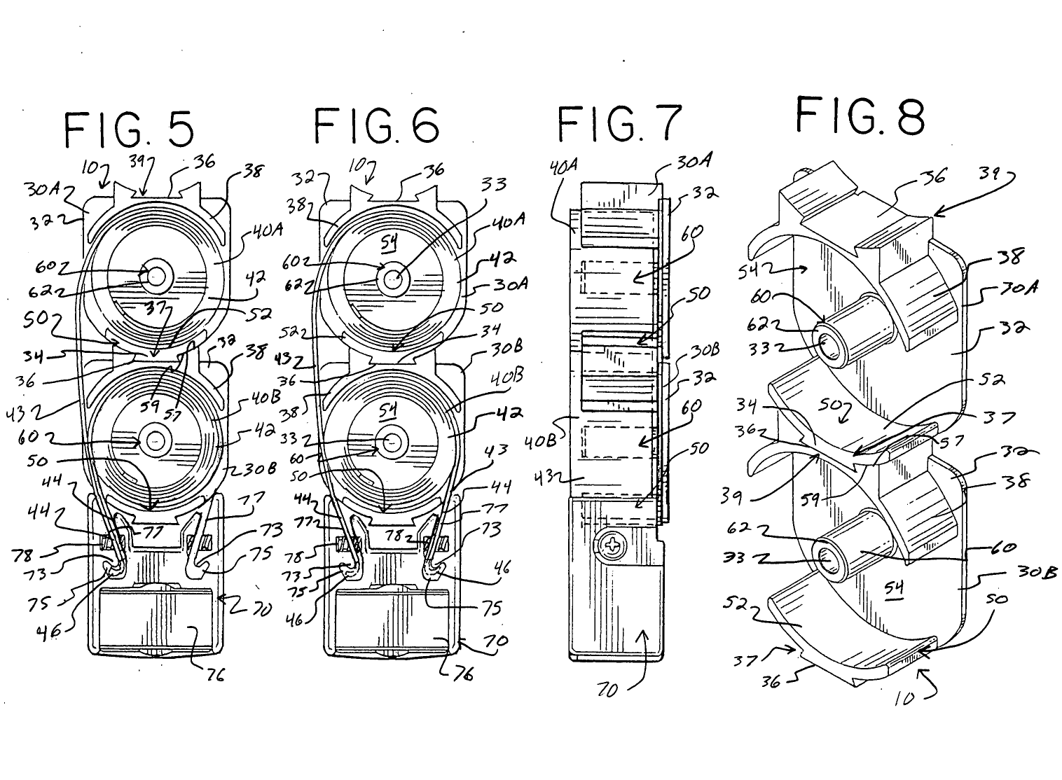

Each coil spring 40 generally has an upper or coiled portion 42 that is coiled and a lower or free portion 43 with a free end 44, as shown in FIGS. 4-6, 11, 12, and 16. In a first configuration, shown in FIGS. 4-6 and 11, the coiled portion 42 of the spring 40 is self-supporting. In a second configuration, shown in FIG. 12, the coiled portion 42 of the spring is mounted upon a drum 64 which supports the spring 40. The drum 64 is preferably a tubular structure adapted to facilitate the rotation of the spring. In addition, the drum 64 can reduce the noise generated by the spring 40 during rotation. The free end 44 of the spring 40 is adapted to be attached to the shoe 70. In one embodiment, shown in FIGS. 4-6, the spring 40 has an opening 48 in the free end 44 that is adapted to engage a fastener 78 or other attachment structure on the shoe 70. However, in other embodiments, the free end 44 may contain other structure to engage the shoe, including a curved or rolled portion 46, as illustrated in FIG. 16 and by broken lines in FIGS. 5-6, and described below.

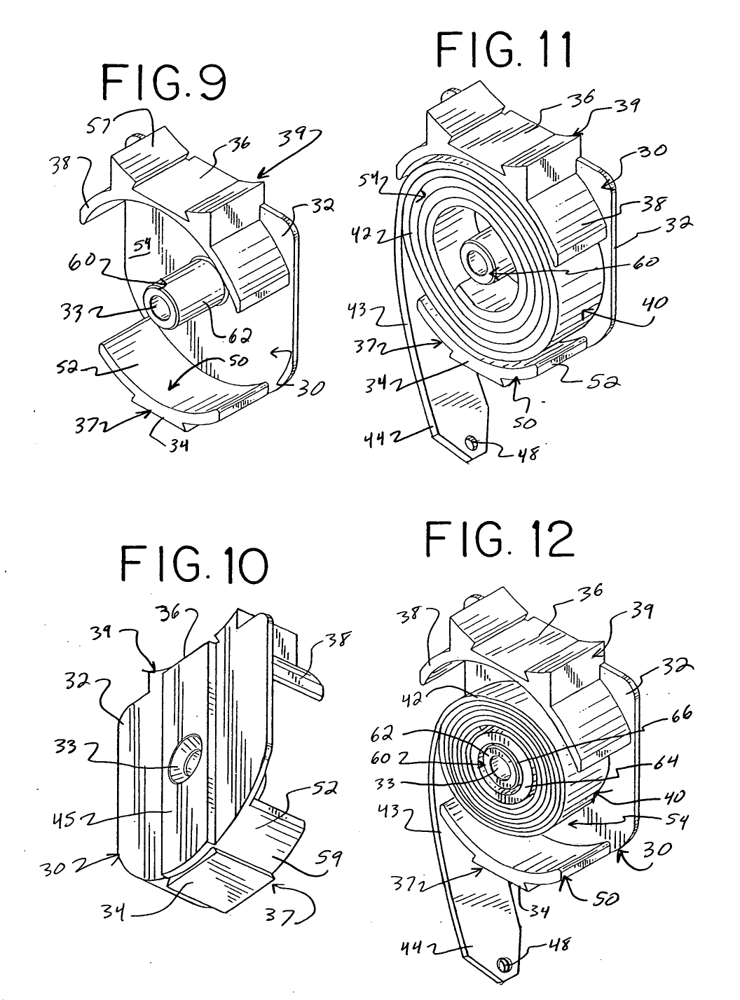

An example of a spring holder 30 of the present invention is illustrated alone in FIGS. 9-10. The spring holder 30 generally includes a plate 32 adapted to be attached to the master frame 110, at least one connector 34,36, a deflector 38, and two spring supports 50, 60. The first spring support 50 is adapted to support the coil spring 40 in a first configuration, and the second spring support 60 is adapted to support the coil spring 40 in a second configuration. The connector 34 of one spring holder 30A is generally adapted to be connected to a cooperatively dimensioned connector 36 of a second spring holder 30B.

The plate 32 supports the other components of the spring holder 30, and is adapted to be attached to the master frame 110 within the channel 113, as shown in FIGS. 3-4. Preferably, the plate 32 has an aperture 33 therethrough, which is adapted to receive a fastener 35, such as a screw 35, as illustrated in FIGS. 3-4. The back side of the plate 32 around the aperture 33 is countersunk for this purpose. In other embodiments, the plate 32 may be adapted to receive a different type of fastener, or may be adapted to connect to the master frame 110 in a different manner. The plate 32 also preferably has a strengthening rib 45 extending along a back side of the plate 32, opposite the second connector 60. This strengthening rib 45 increases the structural strength of the spring holder 30, and is illustrated in FIGS. 3, 4, and 10.

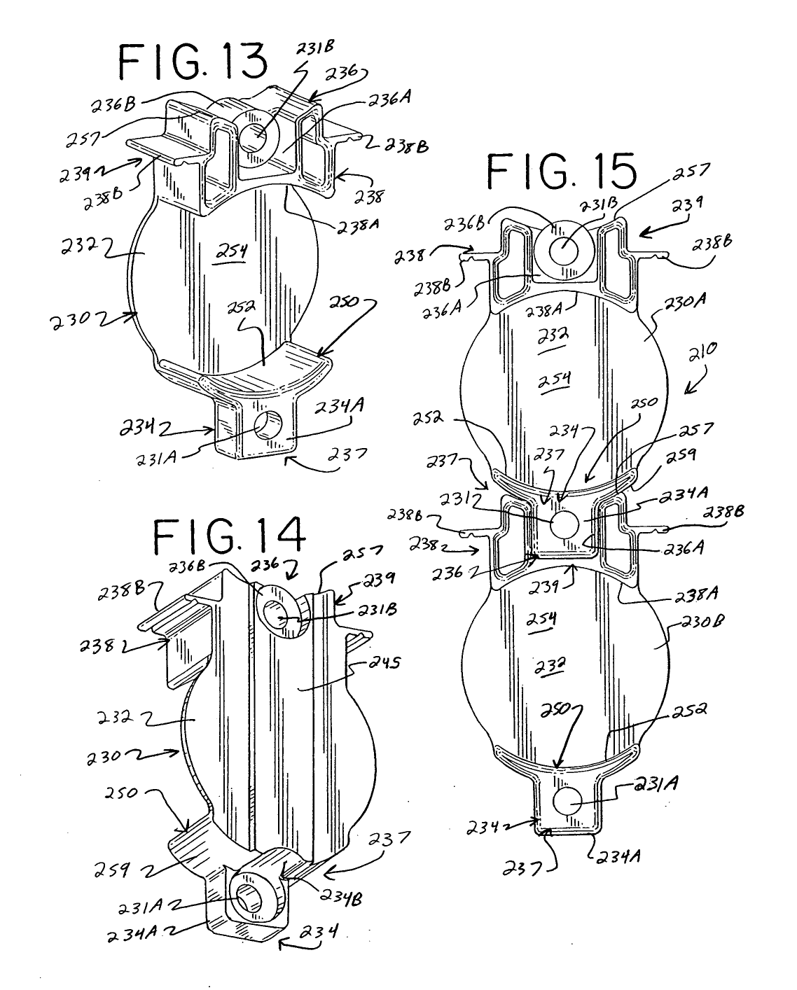

In a preferred embodiment, the spring holder 30 has two connectors 34,36. One connector 34 is cooperatively dimensioned with the other connector 36 such that the first connector 34 of a first spring holder 30A connects to the second connector 36 of a second identical spring holder 30B or the second connector 36 of the first spring holder 30A connects to the first connector 34 of the second spring holder 30B in an alternate connecting arrangement. In the embodiment shown in FIGS. 3-12, one of the connectors 34 is a connection member 34 and the other connector 36 is a receiver 36. Thus, the receiver 36 is cooperatively dimensioned with the connection member 34 such that the receiver 36 of a first spring holder 30A receives the connection member 34 of a second identical spring holder 30B or the receiver 36 of the first spring holder 30A is received by the connection member 34 of the second spring holder 30B in an alternate connecting arrangement. As shown in FIGS. 5-8, the connection member 34 of the first spring holder 30A is received in the receiver 36 of the second spring holder 30B, but as described above, this connection is reversible. In the embodiment shown in FIGS. 3-12, the connection member 34 is a tongue 34 having a dovetail shape, and the receiver 36 is a groove 36 having a dovetail shape. The dovetail shape of the connectors 34,36 provides a secure connection that is quick and easy to create by sliding the tongue 34 into the groove 36. The dovetail connection also provides a connection of minimized length. The connection member 34 is positioned at a first end 37 of the plate 32 and the receiver 36 is positioned at a second end 39 of the plate 32. In the embodiments described herein, the first end 37 is the bottom end 37 of the plate 32, and the second end 39 is the top end 39 of the plate. It is understood that this orientation may be reversed. In other embodiments, the connection member 34 and the receiver 36 may have different shapes. For example, the connectors 234,236 of the spring holder 230 shown in FIGS. 13-15 fit together and are adapted to be connected by a fastener (not shown), as described in more detail below. In still other embodiments, the connection member 34 and the receiver 36 may be configured in a complementary hook arrangement, or may have locking structure such as teeth.

The spring holder 30 has a deflector 38 located proximate the top end 39 of the plate 32. The deflector 38 is preferably a curvilinear deflector plate 38 that depends to the left and right of the connector 36. When the first spring holder 30A is stacked above the second spring holder, as shown in FIGS. 3-8, the deflector 38 prevents the free portion 43 of the upper spring 40A from contacting the lower spring 40B and interfering with the operation of one or both springs 40. The deflector 38 also helps to hold the spring 40 within the spring holder 30.

As described above, the spring holder 30 has a first spring support 50 adapted to support the coil spring 40 in a first configuration, and a second spring support 60 adapted to support the coil spring 40 in a second configuration. The first spring support 50 preferably has a platform 52 affixed to the plate 32 proximate the bottom that the coiled portion 42 of the coil spring 40 sits upon. In the embodiment shown in FIGS. 3-12, the platform 52 is a smoothly-curved cup structure 52 located at the bottom 37 of the plate 32. The circular coiled portion 42 of the spring 40 sits within the curved cup structure 52, and the cup structure 52 supports the spring 40. Viewed another way, the cup structure 52 and the deflector 38 define a cavity 54 on the face of the spring holder 30, and the coiled portion 42 of the spring 40 sits within the cavity. A preferred embodiment of this first configuration, with the coil spring 40 supported by the first spring support 50, is illustrated in FIGS. 5-7 and 11.

The second spring support 60 is located proximate the center of the plate 32 and preferably includes a post 62 adapted to support the coiled portion 42 of the spring 40. In the embodiment shown in FIG. 12, the coiled portion 42 of the spring 40 is mounted upon a drum 64 and the drum 64 is mounted on the second spring support 60. The drum 64 is known to those skilled in the art and is preferably a cylinder having the aperture 66 therein, with the coiled portion 42 of the spring wrapped around the drum 64. The drum 64 is mounted on the post 62 in a freely rotatable manner with the post 62 extending through the aperture 66, so that the free end 44 of the spring 40 can be freely extended and retracted. A preferred embodiment of this second configuration, with the coil spring 40 mounted on a drum 64 that is supported by the post 62, is illustrated in FIG. 12. Additionally, the aperture 33 that receives the screw 35 to attach the spring holder 30 to the master frame 110 preferably extends through the center of the post 62.

As shown in FIGS. 8-10, the spring holder 30 has a concavely curved top 57 that is cooperatively dimensioned with a convexly curved bottom 59 of the spring support 50, and the curved top 57 of the second spring holder 30B contacts the curved bottom 59 of the first spring holder 30A to add additional stability to the connection.

It is understood that the first and second configurations for the spring holder 40, and the first and second spring supports 50,60 may be different from those described above. The structures supporting the spring 40 may be changed to support the spring 40 in the same basic manner, but with different structures. Additionally, the spring supports 50,60 may support the spring 40 in a completely different manner and configuration, and the present invention is not limited to a particular configuration unless specified by the claims.

The shoe or pivot brake assembly 70 is operably connected to the free ends 44 of both the first and second springs 40. In addition, the pivot brake assembly 70 is operably connected to a lower portion of the sash window 104 near the base rail 120. When the pivot brake assembly 70 is coupled to the sash window 104 the balance assembly 10 counterbalances the weight of the sash window 104 by the first and second springs 40 exerting a generally upward force on the sash window 104 when it is moved between the closed and open positions of FIGS. 1 and 2. The pivot brake assembly 70 generally includes a housing 72, a cam 74, and a brake pad 76. The housing 72 of the pivot brake assembly 70 receives and supports the cam 74 and also supports the brake pad 76. The sash window 104 is mounted on the rotatable cam 74, allowing the window 104 to pivot about the shoe 70 and thereby to tilt. When the window 104 is tilted outwardly, the cam 74 rotates and also activates the brake pad 76 to stop sliding of the window 104. It is understood that the pivot brake assembly 70 can be a shoe 70 which does not include a brake pad 76. The structure and function of the brake assembly 70 is described in more detail in U.S. Pat. No. 6,983,513, the disclosure of which is incorporated by reference herein and made part hereof

A preferred embodiment of the assembled balance assembly 10 is illustrated in FIGS. 3-7. Each spring holder 30 has the connection member 34 and the first spring support 50 mounted at the bottom 37 of the plate 32, the receiver 36 and the deflector 38 mounted at the top 39 of the plate 32, and the second spring support 60 mounted at the center of the plate 32. A first spring holder 30A can be quickly and easily attached to a second spring holder 30B by sliding the connection member 34 of the first spring holder 30A into the receiver 36 of the second spring holder 30B, as shown in FIGS. 3-7. Additionally, the curved top 57 of the second spring holder 30B contacts the curved bottom 59 of the first spring holder 30A to add stability to the connection. It is understood that the positions of the two spring holders 30 can be reversed, and that three or more spring holders 30 could potentially be stacked in the same manner. The springs 40 are then mounted on one of the first spring support 50 and the second spring support 60 of each spring holder 30. A spring 40 mounted on the first spring support 50 is shown in FIG. 11, and a spring 40 mounted on a drum 64 that is mounted on the second spring support 60 is shown in FIG. 12. The springs 40 can be mounted in alternating fashion, as shown in FIGS. 3, 4, 6, and 7, where the free portion 43 of the top spring 40A hangs to one side (the left side in FIG. 6) and the free portion 43 of the bottom spring 40B hangs to the opposite side (the right side in FIG. 6). However, the springs 40 can also be mounted so that the free portions 43 of both the top spring 40A and the bottom spring 40B hang from the same side, as illustrated in FIG. 5. As described above, the deflector 38 assists in creating this versatility.

After the balance assembly 10 has been assembled as described above, the balance assembly 10 can be mounted to the master frame 110. In the embodiment shown in FIGS. 3-4, a fastener, such as a screw 35, is inserted through the aperture 33 in each spring holder 40 and into another aperture 115 in the channel 113 in the master frame 110. The fasteners 35 hold the balance assembly 10 securely in place. The plate 32 and the wall of the master frame 110 cooperate to hold the springs 40 in place.

Additionally, the free ends 44 of the springs 40 are connected to the shoe 70, preferably by inserting the free end 44 into a slot 77 in the shoe 70. In the embodiment shown in FIGS. 3-7, the spring 40 has an opening 48 in the free end 44 that is adapted to engage a fastener 78 or other attachment structure on the shoe 70. However, in other embodiments, the free end 44 may contain other structure to engage the shoe 70, including, for example, a curved or rolled portion 46, as illustrated in FIG. 16. The curved portion 46 fits within a curved portion 75 in the slot 77 of the shoe 70 and engages a protrusion 73 defined by the curved portion 75, as shown in broken lines in FIGS. 5-6 and illustrated in U.S. Pat. No. 6,983,513, the disclosure of which is incorporated by reference herein and made part hereof. The sash window 104 is mounted on the shoe 70 as described above, preferably by attachment to the cam 74.

When the pivot brake assembly 70 is coupled to the sash window 104, the free ends 44 of the springs extend and retract along with the window 104 when the window 104 is slid between the closed and open positions of FIGS. 1 and 2, exerting a generally upward force on the sash window 104. Thus, the balance assembly 10 thereby counterbalances the weight of the sash window 104. This counterbalancing force allows the window (which can be heavy) to be easily slid open or closed, because little force is needed for such movement when properly counterbalanced. The window can also preferably be tilted by pivoting about the shoe, which activates the brake pads 76 to lock the window in place, as described above.

Another embodiment of the balance assembly 210 having a different spring holder 230 is illustrated in FIGS. 13-15. Most of the components of this spring holder 230 are generally similar to those described above with respect to the previous embodiment 10 and are numbered consistently with the components of the previous embodiment 10, using the “200” series of reference numbers. Thus, the balance assembly is described herein with respect to the differences from the previous embodiment 10.

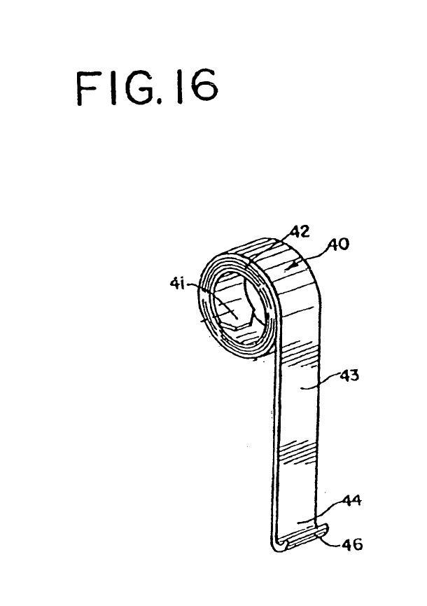

The spring holder 230 has complementary connectors 234,236, which are different in structure than the connectors 34,36 described above. These complementary connectors 234,236 allow one spring holder 230A to be connected to another spring holder 230B, as shown in FIG. 15. The first connector 234 is located at the first end 237 of the spring holder 230, and includes a rectangular connection member 234A extending from the plate 232 and having an aperture 231A therethrough. The second end 239 of the spring holder 230 has a receiver 236A that is cooperatively dimensioned with the connection member 234. Thus, the first connector 234 of the first spring holder 230A can be connected to the second connector 236 of the second spring holder 230B, or the first connector 234 of the second spring holder 230B can be connected to the second connector 236 of the first spring holder 230A. The second connector 236 also has a cylindrical knob 236B having an aperture 231B therethrough. The first connector has a recess 234B that is cooperatively dimensioned to receive a part of the knob 236B to increase the stability of the connection. Further, the spring holder 230 has a convexly curved top 257 that is cooperatively dimensioned with a concavely curved bottom 259 of the spring support 250, and the curved top 257 of the second spring holder 230B contacts the curved bottom 259 of the first spring holder 230A to add additional stability to the connection. Once the spring holders 230 are joined in this manner, the apertures 231 are aligned and a fastener (not shown), such as a screw, can be inserted through the apertures 231 to fasten the spring holders 230 together. This fastener, along with other fasteners inserted through the other apertures 231 can also be used to mount the spring holder to the master frame 110. The back sides of the knob 236B and the connection member 234A around the apertures 231 are countersunk for this purpose.

The spring holder 230 shown in FIGS. 13-15 has only a single spring support 250, which includes a smoothly curved cup structure 252, similar to the first spring support 50 described above. Thus, the spring support 250 can hold a coil spring 40 with the coiled portion 42 of the spring sitting upon the cup structure 252, as with the first spring support 50 described above. The spring support 250 is mounted at the bottom 237 of the plate 232. It is understood that the spring holder 230 may be modified to include a second spring holder (not shown), such as a post 62 as described above, in addition to or in replacement of the spring support 250.

The deflector 238 of the spring holder 230 is shaped differently than the deflector 38 of the previous embodiment 30. The deflector 238 has a smoothly curved surface 238A and two straight wings 238B raised above the curved surface 238A and extending to the left and right of the curved surface 238A.

The balance assembly 10 provides many advantages over prior art balance assemblies and similar mechanisms. The reversible connectivity provided by the connectors 34,36 allows for any number of spring holders 30 to be used with the window assembly 100. This provides an advantage over prior balance assemblies, which are typically designed for a specific mounting arrangement, with little adaptability. The connection structure between the spring holders 30 also minimizes the overall length of the connection, which enhances egress through the sash window assembly. The dual spring supports 50,60 allow for mounting the springs 40 in two different configurations, which gives the consumer a choice between mounting configurations with a single spring holder 30. This also provides an advantage over prior balance assemblies, which typically require a different spring holder for a different mounting configuration. Thus, the present invention also reduces the inventory necessary for a window installer or a distribution center. It is further understood that other hardware structures having suitable connectors can be used and connected to the spring holder 30. For example, hardware components that may cooperate with the tilt latch 130 can be connected to the spring holder 30. One skilled in the art would appreciate still further advantages provided by the present invention.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “top,” “bottom,” etc., as used herein, are intended for illustrative purposes only and do not limit the embodiments in any way. Accordingly, while the specific embodiments have been illustrated and described, numerous modifications come to mind without significantly departing from the spirit of the invention and the scope of protection is only limited by the scope of the accompanying claims.

What is claimed is:

1. A spring holder for a balance assembly for a sash window slidable within a master frame, the sash window having a shoe attached thereto, the balance assembly having a spring having a coiled portion supported by the spring holder and a free end attached to the shoe, the spring holder comprising:
a plate adapted to be attached to the master frame;
a spring support connected to the plate and adapted to support the spring;
a connection member positioned at a first end of the plate; and
a receiver positioned at a second end of the plate opposite the first end,
wherein the receiver is cooperatively dimensioned with the connection member such that in a first connecting arrangement, the receiver of the spring holder receives the connection member of a second identical spring holder, and in a second connecting arrangement, the connection member of the spring holder is received by the receiver of the second identical spring holder.

2. The spring holder of claim 1, wherein the connection member comprises a tongue extending from the first end of the plate.

3. The spring holder of claim 1, wherein the receiver comprises a groove in the second end of the plate.

4. The spring holder of claim 1, wherein the connection member and the receiver both have a dovetail shape.

5. The spring holder of claim 1, wherein the connection member comprises a tongue having a dovetail shape extending from the first end of the plate, and the receiver comprises a groove having a dovetail shape in the second end of the plate.

6. The spring holder of claim 1, further comprising a deflector located proximate the second end of the plate.

7. A balance assembly for a sash window slidable within a master frame, the sash window having a shoe attached thereto, the balance assembly comprising:
a spring having a coiled portion and a free end adapted to be attached to the shoe; and
a spring holder comprising:
a plate adapted to be attached to the master frame;
a first spring support and a second spring support, wherein the spring holder supports the spring in one of a first configuration, wherein the coiled portion of the spring is supported by the first spring support, and a second configuration, wherein the coiled portion of the spring is supported by the second spring support;
a first connector located on the plate; and
a second connector located on the plate,
wherein the first connector is cooperatively dimensioned with the second connector such that in a first connecting arrangement, the first connector of the spring holder connects to the second connector of a second identical spring holder, and in a second connecting arrangement, the second connector of the spring holder connects to the first connector of the second identical spring holder.

8. The balance assembly of claim 7, wherein the first connector comprises a connection member extending from a first end of the plate and the second connector comprises a receiver in a second end of the plate.

9. The balance assembly of claim 8, wherein the connection member comprises a tongue extending from the first end of the plate and the receiver comprises a groove in the second end of the plate.

10. The balance assembly of claim 9, wherein the tongue has a dovetail shape, and the groove has a dovetail shape complementary to the dovetail shape of the tongue.

11. The balance assembly of claim 7, wherein the first spring support comprises a cup structure and the second spring support comprises a post located proximate a center of the plate, wherein in the first configuration, the spring is supported by the first spring support such that the coiled portion of the spring sits within the cup structure, and in the second configuration, the coiled portion of the spring is mounted upon a drum and the drum is mounted on the second spring support.

12. A balance assembly for a sash window slidable within a master frame, the sash window having a shoe attached thereto, the balance assembly comprising:
a spring having a coiled portion and a free end adapted to be attached to the shoe; and
a spring holder comprising:
a plate adapted to be attached to the master frame;
a first spring support comprising a platform; and
a second spring support comprising a post located proximate a center of the plate,
wherein the spring holder supports the spring in one of a first configuration, wherein the spring is supported by the first spring support such that the coiled portion of the spring sits upon the platform, and a second configuration, wherein the spring is supported by the second spring support such that the coiled portion of the spring is mounted upon a drum and the drum is mounted on the second spring support.

13. The balance assembly of claim 12, wherein the plate has a first end and an opposed second end, and the balance assembly further comprises a deflector located proximate the second end of the plate.

14. The balance assembly of claim 13, wherein the first spring support is located proximate the first end of the plate.

15. The balance assembly of claim 12, wherein the platform comprises a cup structure.

16. The balance assembly of claim 15, wherein the cup structure is smoothly curved.

17. The balance assembly of claim 12, wherein the post is adapted to receive a fastener therethrough.

18. A spring holder for a balance assembly for a sash window slidable within a master frame, the sash window having a shoe attached thereto, the balance assembly having a spring having a coiled portion supported by the spring holder and a free end attached to the shoe, the spring holder comprising:
a plate adapted to be attached to the master frame;
a first spring support comprising a platform; and
a second spring support comprising a post located proximate a center of the plate,
wherein the spring holder is adapted to support the spring in one of a first configuration, wherein the spring is adapted to be supported by the first spring support such that the coiled portion of the spring sits upon the platform, and a second configuration, wherein the spring is adapted to be supported by the second spring support such that the coiled portion of the spring is mounted upon a drum and the drum is mounted on the second spring support.

19. A balance assembly for a sash window slidable within a master frame, the sash window having a shoe attached thereto, the balance assembly comprising:
a first spring having a coiled portion and a free end adapted to be attached to the shoe;
a second spring having a coiled portion and a free end adapted to be attached to the shoe;
a first spring holder comprising:
a plate adapted to be attached to the master frame;
a connection member extending from a first end of the plate, comprising a tongue having a dovetail shape;
a receiver positioned at a second end of the plate opposite the first end, comprising a groove having a dovetail shape;
a deflector located proximate the second end of the plate;
a first spring support comprising a smoothly curved cup structure located proximate the first end of the plate; and
a second spring support comprising a post located proximate a center of the plate,
wherein the first spring holder supports the first spring in one of a first configuration, wherein the first spring is supported by the first spring support such that the coiled portion of the first spring sits within the cup structure, and a second configuration, wherein the coiled portion of the first spring is mounted upon a drum and the drum is mounted on the second spring support;
a second spring holder identical to the first spring holder, comprising:
a plate adapted to be attached to the master frame;
a connection member extending from a first end of the plate, comprising a tongue having a dovetail shape;
a receiver positioned at a second end of the plate opposite the first end, comprising a groove having a dovetail shape, the receivers of the first and second spring holders being cooperatively dimensioned with the connection members thereof such that the receiver of the second spring holder receives the connection member of the first spring holder or the receiver of the first spring holder receives the connection member of the second spring holder in an alternate connecting arrangement;
a deflector located proximate the second end of the plate;
a first spring support comprising a smoothly curved cup structure located proximate the first end of the plate; and
a second spring support comprising a post located proximate a center of the plate,
wherein the second spring holder supports the second spring in one of a first configuration, wherein the second spring is supported by the first spring support such that the coiled portion of the second spring sits within the cup structure, and a second configuration, wherein the coiled portion of the second spring is mounted upon a drum and the drum is mounted on the second spring support.

20. The balance assembly of claim 19, wherein the plates of the first spring holder and the second spring holder each have a strengthening rib extending along a back surface thereof.

21. The balance assembly of claim 19, wherein the deflector of the first spring holder is smoothly curved and has a radius of curvature similar to a radius of curvature of the cup structure of the first spring holder, and the deflector of the second spring holder is smoothly curved and has a radius of curvature similar to a radius of curvature of the cup structure of the second spring holder.
